(19) United States
(12) Patent Application Publication
(10) Pub. No.: US 2004/0203661 A1
(43) Pub. Date: Oct. 14, 2004

(54) Method for providing receiver situation mode service and a mobile communication terminal for performing the same

(75) Inventor: Sun-Gi Lee, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/331,256

(22) Filed: Dec. 30, 2002

(30) Foreign Application Priority Data
Jun. 1, 2002 (KR) 2002-30911

(51) Int. Cl. H04M 3/42

(52) U.S. Cl. 455/414.1; 455/456.1

(57) ABSTRACT

A mobile communication terminal for providing a receiver situation mode service. The mobile communication terminal includes a memory for storing a table including data representing a plurality of situation modes of the receiver and codes corresponding to the plurality of situation modes of the receiver and for temporarily storing a code representing a predetermined situation mode of the receiver selected from the plurality of situation modes of the receiver by a user. The mobile communication terminal has a control section for storing a code corresponding to the selected situation mode of the receiver with reference to the table when the predetermined situation mode of the receiver is selected, and for transmitting a code representing the predetermined situation mode of the receiver selected by the user together with location registration information of a terminal upon receiving a message requesting a location registration of the terminal.

### PRIORITY

This application claims priority to an application entitled “Method For Providing Receiver Situation Mode Service And Mobile Communication Terminal For Performing The Same” filed in the Korean Industrial Property Office on Jun. 1, 2002 and assigned Serial No. 2002-30911, the contents of which are hereby incorporated by reference.

### BACKGROUND OF THE INVENTION

1. Field of the Invention

The present invention relates to a mobile communication system, and more particularly to a method for providing a situation mode service of a receiver in a mobile communication terminal of a mobile communication system.

2. Description of the Related Art

An incoming call received in a conventional mobile communication terminal is indicated to a receiver by means of a bell sound, a vibration, or a light-emitting device. When the receiver cannot respond to the call, for example, when the receiver is in a meeting or is watching a performance, the receiver switches the bell sound mode to the vibration mode or turns off the power of the mobile communication terminal in order to shut off the sound. In this case, since a transmitter of the call does not recognize the situation of the receiver, the transmitter again tries the telephone call to communicate with the receiver, but the receiver still cannot respond to the transmitter.

If this situation is repeated, the mobile communication terminal of the transmitter unnecessarily wastes power and a meaningless communication occurs between the mobile communication terminal of the transmitter and a base station.

If the receiver notifies the situation of the receiver to the transmitter when the receiver cannot respond to the transmitter, the transmitter will not repeatedly try the call to the receiver. That is, the transmitter may try the call after a predetermined time lapses, or wait for a return call from the receiver.

### SUMMARY OF THE INVENTION

Accordingly, the present invention has been designed to solve the above-mentioned problems occurring in the prior art, and an object of the present invention is to provide a method and an apparatus for providing information about a situation of a receiver to a transmitter by setting a situation mode of the receiver in a mobile communication terminal, thereby preventing unnecessary telephone calls and a waste of power in the mobile communication terminals of the receiver and transmitter, while reducing the power consumption and saving radio resources of a base station.

In order to accomplish the above and other objects, there is provided a mobile communication terminal for providing a receiver situation mode service, the mobile communication terminal comprising a memory for storing a table including data representing a plurality of situation modes of the receiver and codes corresponding to the various situation modes of the receiver, and for temporarily storing a code representing a predetermined situation mode of the receiver selected from a plurality of situation modes of the receiver by a user; and a control section for storing a code corresponding to the selected situation mode of the receiver with reference to the table when the predetermined situation mode of the receiver is selected, and for transmitting a code representing the predetermined situation mode of the receiver selected by the user together with location registration information of a terminal upon receiving a message requesting a location registration of the terminal.

### BRIEF DESCRIPTION OF THE DRAWINGS

The above and other objects, features, and advantages of the present invention will be more apparent from the following detailed description taken in conjunction with the accompanying drawings, in which:

FIG. 1 is a block diagram of a mobile communication system according to the present invention;

FIG. 2 is a flow chart illustrating setting a receiver situation mode in a mobile communication system according to the present invention;

FIG. 3 is a flow chart illustrating canceling a receiver situation mode in a mobile communication system according to the present invention;

FIG. 4 is a flow chart illustrating a processing procedure of a call to be received/transmitted between a mobile communication terminal and a base station through a switching apparatus;

FIG. 5 illustrates a call processing flow when the present invention is applied to a UMTS;

FIG. 6 is a block diagram of a mobile communication terminal according to the present invention;

FIG. 7 illustrates a processing procedure of a receiver situation mode service according to one embodiment of the present invention;

FIG. 8 illustrates a processing procedure of a receiver situation mode service according to another embodiment of the present invention;

FIG. 9 illustrates a control flow for registering a situation mode of a receiver in a mobile communication terminal according to the present invention;

FIG. 10 illustrates a display screen for selecting a situation mode of a receiver according to the present invention; and

FIG. 11 illustrates a control flow when a situation mode of a receiver is received in a mobile communication terminal according to the present invention.

### DETAILED DESCRIPTION OF THE PREFERRED EMBODIMENT

A preferred embodiment of the present invention will be described herein below with reference to the accompanying drawings. In the following description of the present invention, a detailed description of known functions and configurations incorporated herein will be omitted when it may make the subject matter of the present invention rather unclear.

In a current mobile communication system, a connection procedure between a call-outgoing terminal and a call-incoming terminal is as follows. First, when the call-outgoing terminal requires a call connection, synchronization and channel assignment with respect to a call-outgoing base station are carried out. A call-incoming base station transmits a message indicating the voice communication to the call-incoming terminal and a service connection message, upon notification that voice communication is requested. Thus, a service connection completion message is sent to the call-outgoing base station by an incoming call to indicate that the communication is connected.

According to the present invention, in a call standby state, a user of the mobile communication terminal who cannot respond to the incoming call registers the user's situation in the mobile communication system, so that the mobile communication system can provide information to a transmitter, allowing the transmitter to recognize the situation of the receiver.

In detail, when the user of the mobile communication terminal will not be able to respond to an incoming call, the user registers the situation mode of the receiver in a home location register to notify the situation of the receiver. If the incoming call requesting the voice communication or data communication demanding an immediate answer is received in the mobile communication terminal of the user who has registered the situation mode of the receiver in the home location register, the mobile communication system searches for the situation mode of the receiver from the home location register in the mobile communication network. If the situation mode of the receiver is registered, a switching apparatus transmits a message or voice data to the call-outgoing terminal to inform the situation of the receiver to the transmitter without connecting the call to the call-incoming terminal of the receiver. Thus, the transmitter can recognize the situation of the receiver who will not able to respond to the incoming call. At this time, the transmitter can select other service functions besides voice communication, preventing a waste of time and power consumption of the mobile communication terminal.

In addition, the base station and a core network can recognize the call rejection state of the receiver from an initial stage of the call processing procedure, so the wireless resource required for processing the call can be saved and the efficiency of the wireless resource in a cell of the base station can be improved while reducing the load.

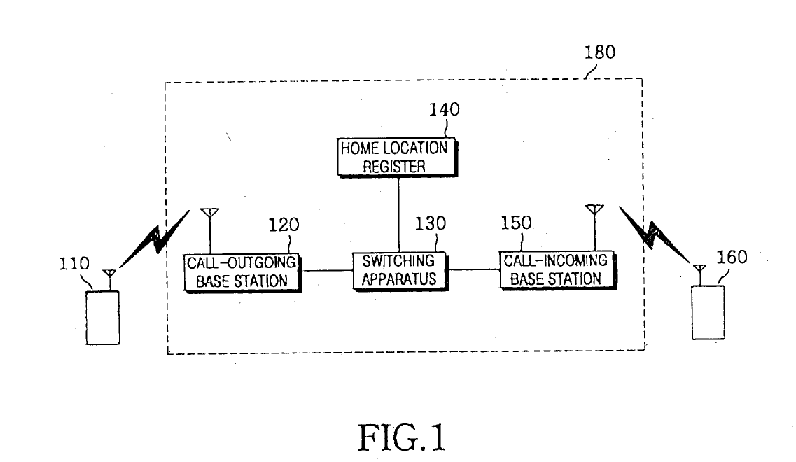

FIG. 1 illustrates a mobile communication system according to the present invention. Referring to FIG. 1, when a user who cannot respond to an incoming call inputs a key for setting a situation mode of the receiver, the mobile communication terminal 160 transmits a code for setting the selected situation mode of the receiver to the corresponding base station 150. The base station 150 transmits data received from the mobile communication terminal to a switching apparatus 130. The switching apparatus 130 registers the data regarding the situation mode of the receiver, which has been selected from the mobile communication terminal 160 of the receiver, to the home location register 140 (hereinafter, referred to HLR). The HLR 140 stores the data regarding the situation mode of the receiver.

More specifically, a call-outgoing terminal 110 is connected to a switching apparatus 130 through a call-outgoing base station 120 in order to connect the call to a call-incoming terminal 160. Then, the switching apparatus 130 requests information of the incoming call to an HLR 140 in order to connect the call. The HLR 140 searches for the database for the receiver and transmits information regarding the situation mode of the receiver to the switching apparatus 130. If the switching apparatus 130 determines that the situation mode of the receiver is set based on information transmitted from the HLR 140, a channel for setting the call is not set up in the call-incoming terminal 160 through a call-incoming base station 150. Instead, datum according to the situation mode of the receiver, such as an SMS message or voice message, are transmitted into the call-outgoing terminal 110. To notify the situation of the receiver to the transmitter, short texts, bell sound, music, pictures, moving pictures, and photos can be utilized.

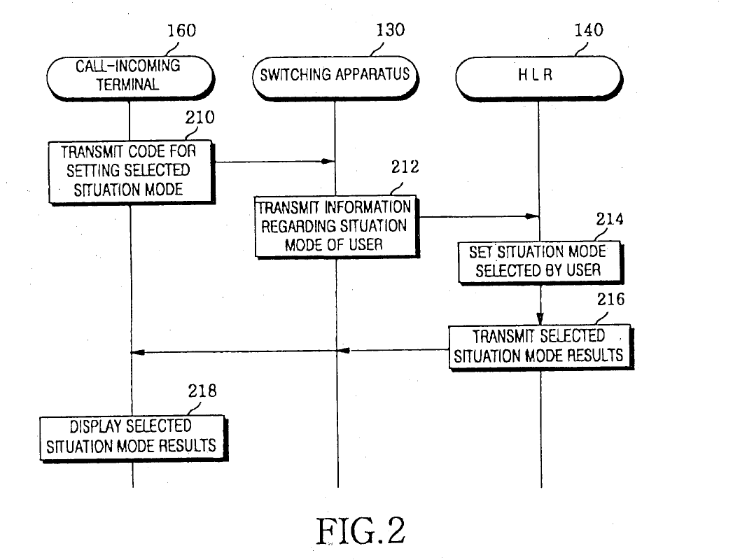

FIG. 2 is a flow chart illustrating setting a receiver situation mode in a mobile communication system according to the present invention. Referring to FIGS. 1 and 2, the user inputs a key for setting a predetermined situation mode of the receiver among a plurality of situation modes into the call-incoming terminal 160, and the call-incoming terminal 160 transmits data including the code for setting the situation mode of the receiver to the switching apparatus 130 in Step 210. The plurality of situation modes include in class, in a meeting, taking a lesson, driving, taking a bath, in a rest room, having a meal, watching a sports game, exercising, sleeping, in a library, etc. These situation modes of the receiver are set in the mobile communication system 180 by the user so that the transmitter can recognize the situation of the receiver who cannot respond to the incoming call. Then, the switching apparatus 130 transmits information regarding the situation mode of the receiver, which is sent from the call-incoming terminal 160, to the HLR 140 in Step 212. The HLR 140 sets the selected situation mode of the receiver in Step 214, and transmits the result to the call-incoming terminal 160 through the switching apparatus 130 in Step 216. Then, the call-incoming terminal 160 displays a message informing that the situation mode of the receiver is set and cancels the call connection in Step 218.

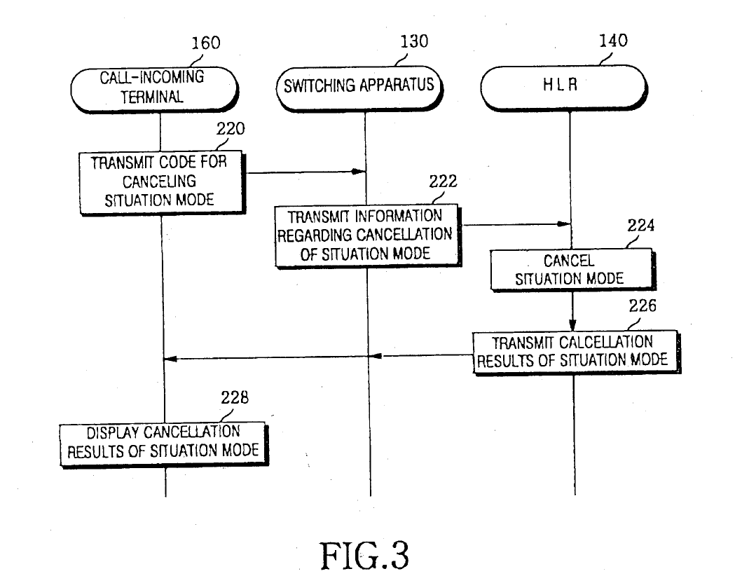

FIG. 3 a flow chart illustrating canceling the receiver situation mode from the mobile communication system according to the present invention Referring to FIGS. 1 and 3, when a key for canceling the situation mode of the receiver set by the user is input into the call-incoming terminal 160, the call-incoming terminal 160 transmits data, including the code for canceling the situation mode of the receiver to the switching apparatus 130 in Step 220. After canceling the situation mode of the receiver set in the mobile communication system 180, the user can respond to a call transmitted by the transmitter. Then, the switching apparatus 130 transmits information according to the cancellation of the situation mode of the receiver, which is sent from the call-incoming terminal 160, to the HLR 140 in Step 222. Thus, the HLR 140 cancels the situation mode of the receiver in Step 224 and transmits the result to the call-incoming terminal 160 through the switching apparatus 130 in Step 226. Then, the call-incoming terminal 160 displays a message informing that the situation mode of the receiver has been canceled and closes the call-connection.

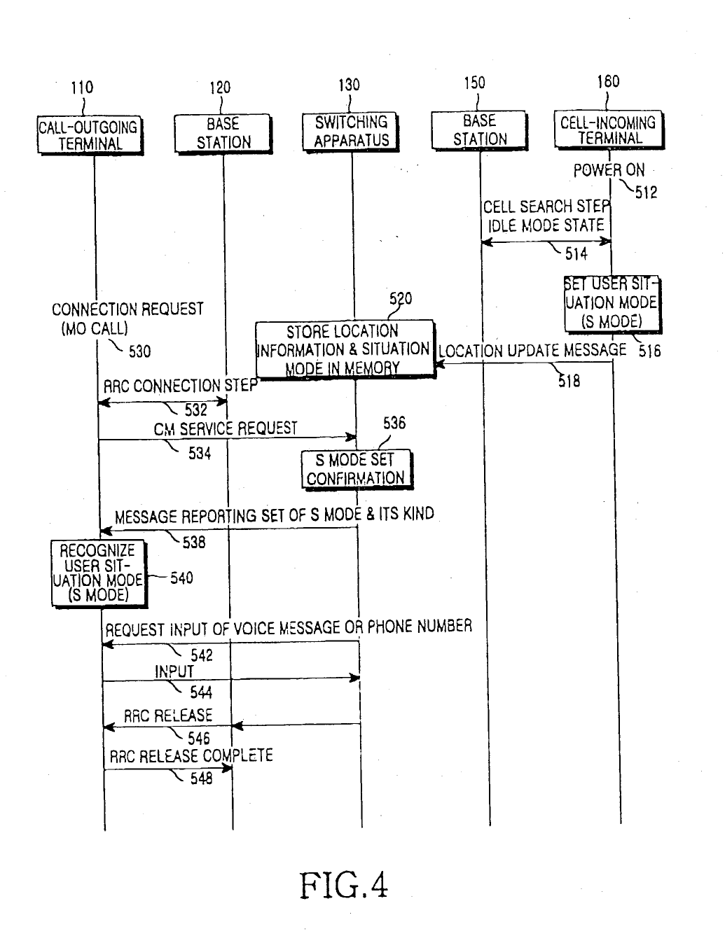

FIG. 4 is a flow chart illustrating a processing procedure of a call received/transmitted between a mobile communication terminal and a base station.

According to the present invention, when a base station sends a message requesting a registration of a location of a mobile communication terminal, information regarding a location registration of the terminal is simultaneously transmitted while the call-incoming terminal is in an idle mode. The content is received in the core network (that is, stored in a core network memory or in the HLR) in order to inform as to the situation mode of the receiver in an initial stage when the terminal of the transmitter requests the call connection. When the call-outgoing terminal requests the call connection, the core network, which stores information regarding the situation mode of the receiver in the memory or in the HLR, compares situation mode information registered by the call-incoming terminal with a data table stored in the memory including the HLR (if call-incoming terminal has a different situation mode table , code values are translated), and transmits the call to the call-incoming terminal based on the compared value, or a download is carried out by using an additional service having a value adapted for the situation mode table. At this time, the core network may check whether the communication service requires the voice communication or a real time response in an initial stage of the call connection of the call-outgoing terminal. Hereinafter, the present invention will be described with reference to the accompanying drawings.

Referring to FIGS. 1 and 4, when the call-incoming terminal 160 is powered on in Step 512, a cell search is carried out in Step 514 and the call-incoming terminal 160 maintains an idle mode state. In the idle mode state of the mobile communication terminal, the mobile communication terminal can receive or transmit the call while synchronizing with the base station. The user of the call-incoming terminal 160 sets the situation mode of the receiver in Step 516, and the call-incoming terminal 160 transmits information regarding the situation mode of the receiver to the switching apparatus 130 when sending the message for registering the location of the call-incoming terminal 160 in Step 518. The switching apparatus 130 stores information regarding the situation mode of the receiver as well as location information of the call-incoming terminal 160 in the HLR 140 in Step 520. That is, the switching apparatus 130 stores information regarding the situation mode of the receiver when location information of the call-incoming terminal 160 is renewed.

When the call-outgoing terminal 110 requests a call connection in Step 530, an RRC (radio resource control) connection is achieved with respect to the call-outgoing base station 120 in Step 532, and a call requesting the communication service including the voice communication or real time response with respect to the call-incoming terminal 160 is transmitted into the switching apparatus 130 in Step 534. The switching apparatus 130 reads out location information of the call-incoming terminal 160 from the HLR 140 and determines whether or not the situation mode of the receiver is set in Step 536. At this time, if the situation mode of the receiver is set in the call-incoming terminal 160, the switching apparatus 130 transmits a message informing the setting and the sort of the situation mode of the receiver to the call-outgoing terminal 110, without forming a channel for connecting the call in the call-incoming terminal in Step 538. Accordingly, the call-outgoing terminal 110 receives the situation mode of the receiver from the switching apparatus 130 in Step 538. The call-outgoing terminal recognizes the situation mode of the receiver in Step 540. At this time, the call-outgoing terminal 110 can be instructed to leave a voice message or a telephone number by the switching apparatus 130 in Step 542. When the call-outgoing terminal 110 inputs the corresponding data into the switching apparatus 130 in Step 544, the switching apparatus 130 releases the RRC connection with respect to the call-outgoing terminal 110 in Step 546. The call-outgoing terminal 110 transmits an RRC release completion message to the call-outgoing base station 120 in response to an RRC connection cancel message in Step 548.

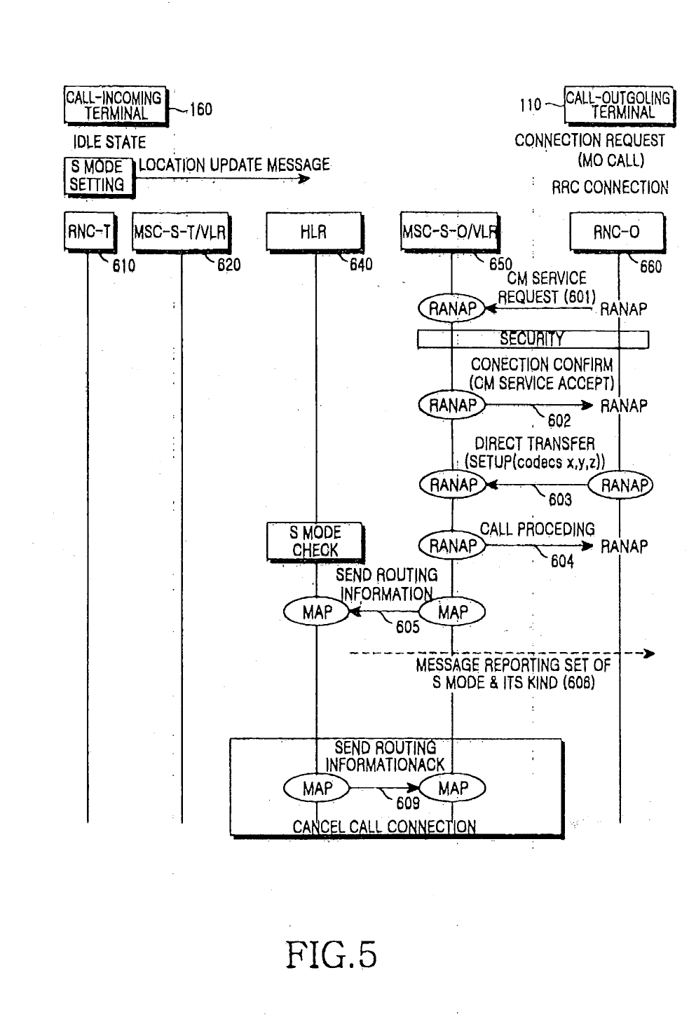

FIG. 5 illustrates a call processing flow when the present invention is applied to a UMTS (universal mobile telecommunication system). Referring to FIG. 5, the UMTS is a European standard for a broadband wireless multimedia service. In FIG. 5, an RNC-T 610 (radio network controller terminated) and an RNC-O 660 (radio network controller oriented) are wireless control stations which deal with a wire/wireless channel manage terminal protocol interface, a base station protocol interface, and a control system processing function.

If the user of the call-incoming terminal 160 sets the situation mode of the receiver, it is assumed that information regarding the setting of the situation mode of the receiver is transmitted when the location renewal message is transmitted to the HLR 640 through the RNC-T 610. When the call-outgoing terminal 110 is RRC-connected to the RNC-O 660, requiring voice communication or a real time response to the call-incoming terminal 160, the RNC-O 660 transmits a call connection request (CM: connection management service request) to an MSC-S-O/VLR 650 (MSC-S-O/VLR: Mobile Services Switching Center-Service-Oriented/Visitor Location Register) through an RANAP (radio access network application protocol) in Step 601. Then, the MSC-S-O/VLR 650 transmits an Ack for a CM service accept to the RNC-O 660 in Step 602. The RNC-O 660 transmits a DT (direct transfer) with respect to the call-incoming terminal 160 to the MSC-S-O/VLR 650 in Step 603, and the MSC-S-O/VLR 650 transmits an Ack (call proceeding) with respect to the DT to the RNC-O 660 in Step 604. The MSC-S-O/VLR 650 transmits routing information regarding the call-outgoing terminal to the HLR 640 through a MAP (management application protocol) in Step 605. Thus, the HLR 640 searches for location information of the call-incoming terminal 160 and checks whether or not the situation mode of the receiver is set. If the situation mode of the receiver has been set, the HLR 640 sends a message informing the setting and the sort of the situation modes of the receiver to the RNC-O 660, without forming a channel for the call connection with respect to the call-incoming terminal 160 in Step 606. Then, the HLR 640 transmits requesting input of voice message or phone number and release information to the MSC-S-O/VLR 650 in order to cancel the call connection in step 609. But if the situation mode of the receiver is not set, the HLR 640 transmits a roaming number to the MSC-S-T/VTR (Mobile Services Switching Center-Service-Terminated/Visitor Location Register) 620. The MSC-S-T/VLR 620 transmits an Ack with respect to the roaming number to the HLR 640. If the receiver doesn't respond to the transmitter, the HLR 640 transmits routing information to the MSC-S-O/VLR 650 in order to cancel the call connection.

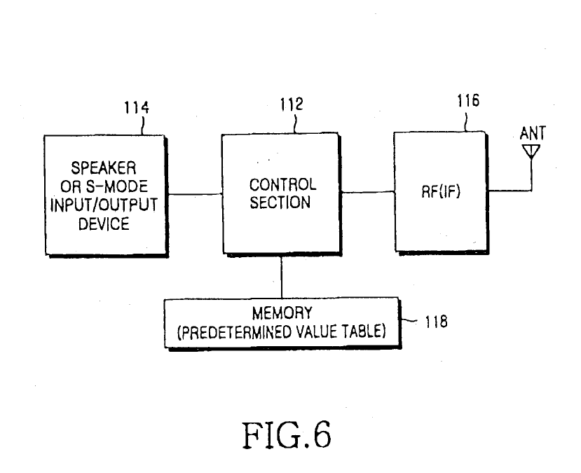

FIG. 6 is a block diagram of a mobile communication terminal according to the present invention. In FIG. 6, a control section 112 processes and controls the voice communication or data communication in the mobile communication terminal according to the situation mode of the receiver. Therefore, the processing and control functions of the control section 112 will not be further described below.

A memory 118 stores program data required for controlling an operation of the mobile communication terminal. In addition, the memory 118 stores a predetermined value table including data representing a plurality of situation modes of the receiver and codes corresponding to the plurality of situation modes of the receiver. more specifically, the predetermined value table has an intrinsic code for setting the situation mode of the receiver selected by the user from various situation modes of the receiver, such as in class, in a meeting, taking a lesson, driving, taking a bath, in a rest room, having a meal, watching a sport game, exercising, sleeping, in a library, etc. In addition, the predetermined value table stores data including an icon or a voice message for displaying the situation mode of the receiver to the user. Accordingly, when the user selects one situation mode of the receiver from the various situation modes of the receiver, the control section 112 stores the code corresponding to the selected situation mode of the receiver in the memory 118. Then, when the base station transmits the message requesting the location registration of the terminal in an idle state of the call-incoming terminal, the control section 112 transmits the selected situation mode of the receiver together with information regarding the location registration of the terminal to the base station.

The predetermined value table can be downloaded from each mobile communication company. In addition, the control section 112 can receive the code regarding the situation mode of the receiver from the base station with respect to the communication service call requesting voice communication or the real time response. At this time, the control section 112 provides information regarding the situation mode of the receiver corresponding to the code of the selected situation mode of the receiver to the user through a situation mode input/output device 114 with reference to the predetermined value table stored in the memory 118.

The situation mode input/output device 114 has a display section including a microphone, a speaker, or a display, and an input section including a keypad. The input section has a plurality of numerical keys and functional keys for inputting key data to the control section 112 when the user presses one of the keys. The display can include an LCD (liquid crystal display) or a TFT-LCD (thin film transistor liquid crystal display).

An RF (radio frequency) module 116 is connected to the control section 112 in order to transmit/receive a wireless signal to/from the base station of the mobile communication system through an antenna ANT. The RF module 116 modulates a signal, which is input from the control section 112 to a base band processing section (not shown), transmits an RF signal through the antenna ANT, and provides the RF signal received through the antenna ANT to the control section 112 from the base band processing section by demodulating the RF signal.

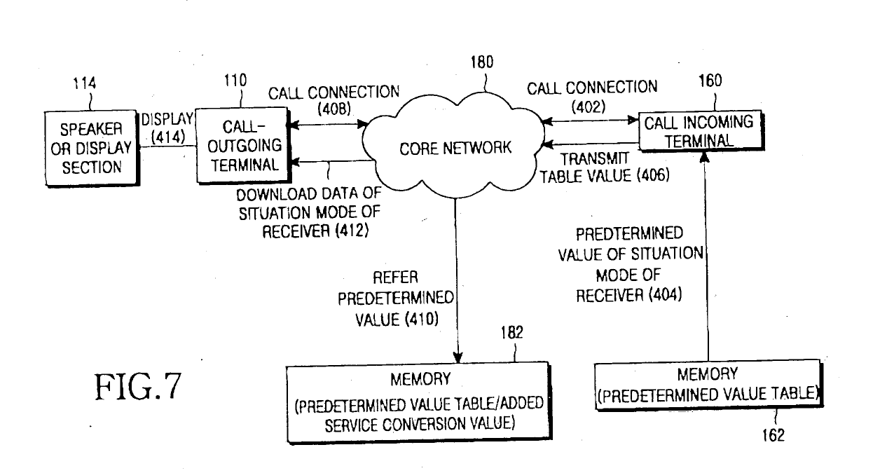

FIG. 7 illustrates a processing procedure of a receiver situation mode service according to one embodiment of the present invention. Though some components are illustrated in FIG. 7 for explaining the present invention, it will be understood by those skilled in the art that the present invention can include other components.

Referring to FIGS. 1 and 7, the call-outgoing terminal 110 is connected to the call-incoming terminal 160 through the core network 180. Although the core network 180 illustrated in FIG. 1 includes base stations 120 and 150, switching apparatus 130 and home location register 140, the core network 180 illustrated in FIG. 7 can include various wireless communication systems for connecting a call-outgoing terminal 110 to a call-incoming terminal 160.

As described above, the call-outgoing terminal 110 illustrated in FIG. 7 includes the situation mode input/output device 114 including the display section including the microphone, the speaker, and the display, and the input section including the keypad.

In addition, the call-incoming terminal 160 includes a memory 162 for storing the predetermined value table including codes representing a plurality of situation modes of the receiver.

In addition, similar to the call-incoming terminal 160, the core network 180 also includes a memory 182 for storing the predetermined value table having codes representing a plurality of situation modes of the receiver. The memory 182 of the core network 180 can store predetermined data, such as SMS messages, telephone numbers, or voice messages, which are provided to the call-outgoing terminal 110 corresponding to the situation modes of the receiver.

Referring to FIG. 7, when the user cannot respond to the received communication service call requesting voice communication or real time response, the call-incoming terminal 160 is connected to the code network 180 in Step 402, and outputs a code value corresponding to the situation mode of the receiver selected by the user with reference to the predetermined value table stored in the memory 162 in Step 404. Then, the call-incoming terminal 160 transmits the code value to the core network 180, thereby setting the situation mode of the receiver in Step 406. After that, when the call-outgoing terminal 110 is connected to the call-incoming terminal 160 for the call connection in Step 408, the core network 180, if the situation mode of the receiver is set in the call-incoming terminal 160, searches the memory 182 of the core network 180 in Step 410 and transmits various data including the SMS message and the voice message corresponding to the situation mode of the receiver to the call-outgoing terminal 110 in Step 412. Thus, the call-outgoing terminal 110 outputs the situation mode of the receiver through the display section 114. At this time, the SMS message or an MMS message is displayed in the display of the display section 114 and the voice message is outputted through the speaker of the display section 114. Then, the call-outgoing terminal 110 can receive the message to leave the voice message or the telephone number of the transmitter for the user of the call-incoming terminal 160 from the core network 180. If the user of the call-outgoing terminal 110 transmits the voice message or the telephone number to the core network 180, the core network 180 later provides a voice message or the telephone number of a transmitter to the user of the call-incoming terminal 160.

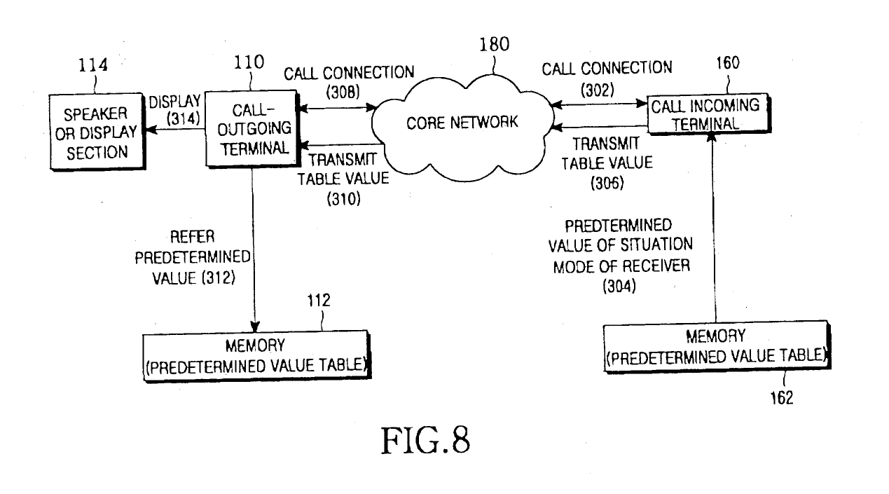

FIG. 8 illustrates a processing procedure of a receiver situation mode service according to another embodiment of the present invention. Referring to FIG. 8, the call-incoming terminal 160 and the call-outgoing terminal 110 have the memories 162 and 112 for storing the predetermined value table including codes representing a plurality of situation modes of the receiver, respectively. Accordingly, after the call-incoming terminal 160 is connected to the core network 180 for setting the situation mode of the receiver in Step 302, the code value corresponding to the situation mode of the receiver selected by the user is transmitted into the core network 180 with reference to the memory 162 in Step 306. Then, if the call-outgoing terminal 110 transmits the call connection signal to the call-incoming terminal 160 in Step 308, the core network 180 transmits the table value, which is predetermined by the call-incoming terminal 160, to the call-outgoing terminal 110 in Step 310. Thus, the call-outgoing terminal 110 searches for the predetermined value table stored in the memory 112 according to the received code value in Step 312 and displays information regarding the situation mode of the receiver to the user of the call-outgoing terminal 110 in Step 314.

In addition, when the mobile communication terminal is connected to the switching apparatus so as to set the situation mode of the receiver, the switching apparatus provides a guide picture representing various situation modes of the receiver, so that the user of the mobile communication terminal can select one of the situation modes of the receiver. In this case, the mobile communication terminal does not require the memory for storing the predetermined value table including codes representing various situation modes of the receiver.

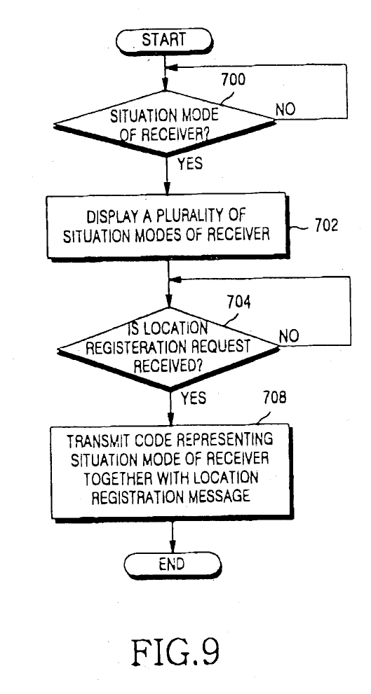

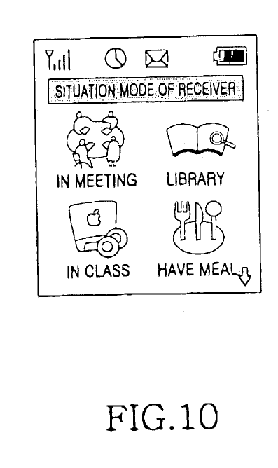

FIG. 9 illustrates a control flow for registering the situation mode of the receiver in the mobile communication terminal according to the present invention, and FIG. 10 illustrates a display screen for selecting the situation mode of the receiver according to the present invention.

Referring to FIGS. 6 and 9, the control section 112 of the mobile communication terminal checks whether or not the situation mode of the receiver has been entered in Step 700. The situation mode of the receiver is entered when the user of the mobile communication terminal operates the input section of the situation mode input/output device 114, that is, when the user pushes a predetermined key on the keypad. At this time, it is possible for the user to make a “hot key” on the keypad in order to enter the situation mode of the receiver immediately. When the situation mode of the receiver is entered, the control section 112 displays the sorts of situation modes of the receiver by means of icons and corresponding text information as illustrated in FIG. 10 in step 702. In addition, the control section 112 can display the sorts of the situation modes of the receiver in the display section as predetermined text information. As mentioned above, the sorts of the situation modes of the receiver include in class, in a meeting, taking a lesson, driving, taking a bath, in a rest room, having a meal, watching a sports game, exercising, sleeping, in a library, etc. When the user selects one of the situation modes of the receiver displayed on the display section, the control section 112 stores the code corresponding to the selected situation mode of the receiver in the memory with reference to the predetermined value table. Then, the control section 112 checks whether or not the message requesting the registration of the terminal location has been received in Step 704. If the message requesting the registration of the terminal location has been transmitted from the core network, the control section 112 transmits the code representing the situation mode of the receiver together with the location registration message to the core network 180 (Step 708). Accordingly, the core network 180 stores location information of the mobile communication terminal and the code corresponding to the situation mode of the receiver in the memory 182.

When the call connection request to the mobile communication terminal is received, the core network searches location information of the call-incoming terminal stored in the memory 182 and checks whether or not the situation mode of the receiver has been set. If the situation mode of the receiver has been set, the core network transmits information regarding the situation mode of the receiver to the call-outgoing terminal, instead of the response message for the call connection request, by using a wireless channel without transmitting a paging message for the call connection.

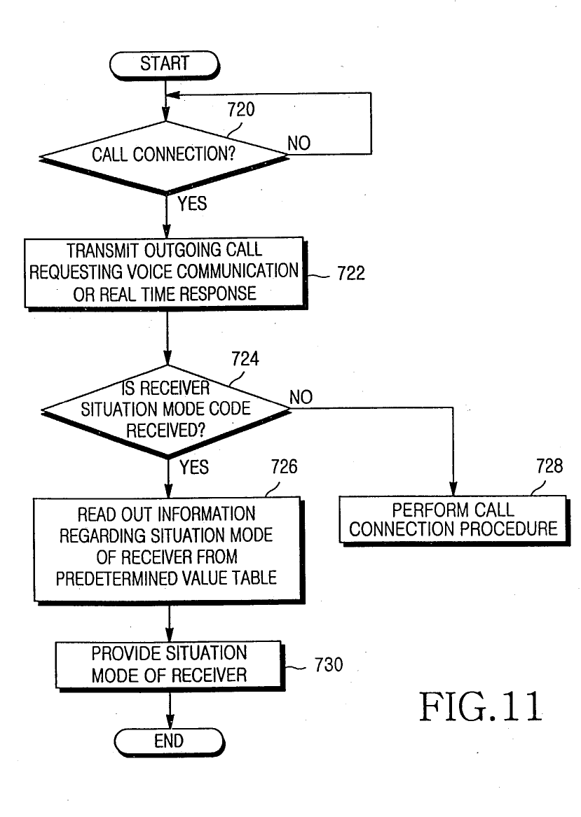

FIG. 11 illustrates a control flow when the situation mode of the receiver has been received in the mobile communication terminal according to the present invention. Referring to FIGS. 6 to 11, the control section 112 of the mobile communication terminal checks whether or not the user is attempting the call connection in Step 720. If the user is attempting the call connection, the control section 112 transmits the communication service call signal requesting voice communication or real time response with respect to the call-incoming terminal 160 to the core network in Step 722. Then, the control section 112 determines whether or not the response message for the call connection request or the code corresponding to the situation mode of the receiver is received in Step 724. If the response message for the call connection request is received, the control section 112 performs the processing procedure for the call connection in Step 728.

If the code corresponding to the situation mode of the receiver is received instead of the response message for the call connection request in Step 724, the control section 112 reads and then transmits information regarding the situation mode of the receiver corresponding to the code relating to the situation mode of the receiver transmitted from the core network to the situation mode input/output device 114, with reference to the predetermined value table stored in the memory in Steps 726 and 730.

Selectively, the control section 112 can receive the signal requesting the voice message or the telephone number of the transmitter from the core network. If the user of the mobile communication terminal transmits the voice message or the telephone number to the core network, the core network later transmits the voice message or the telephone number of the transmitter to the user of the call-incoming terminal.

According to the present invention, a user of a mobile communication terminal can set a situation mode of the receiver in the mobile communication system when the user of the mobile communication terminal will not able to respond to the incoming call, so a transmitter of a call can select another service item instead of voice communication or real time response based on the situation of the receiver, thereby preventing a waste of time for the transmitter and reducing the power consumption of the terminal. In addition, the base station and the core network can find the call connection that has been rejected by the receiver in an early stage before the call connection procedure has been processed, so wireless resources to be used in the next call processing step are saved. Accordingly, the efficiency of wireless resources in a cell of the base station is improved and the load is reduced.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A mobile communication terminal for providing a receiver situation mode service, the mobile communication terminal comprising:
a memory for storing a table including data representing a plurality of situation modes of the receiver and codes corresponding to the plurality of situation modes of the receiver, and for temporarily storing a code representing a situation mode of the receiver selected by a user from the plurality of situation modes of the receiver; and
a control section for storing the code corresponding to the selected situation mode of the receiver with reference to the table when the situation mode of the receiver is selected, and for transmitting the code representing the situation mode of the receiver selected by the user together with location registration information of the mobile communication terminal upon receiving a message requesting a location registration of the mobile communication terminal.

2. A mobile communication terminal as claimed in claim 1, wherein the control section transmits a communication service call requesting voice communication or a real time response, and, when the code representing the situation mode of the receiver is received in the control section in response to the communication service call, the control section transmits information regarding the situation mode of the receiver corresponding to the received code with reference to the table to the user.

3. A mobile communication terminal as claimed in claim 2, wherein information regarding the situation mode of the receiver is at least one of an icon and a voice message.

4. A mobile communication terminal as claimed in claim 1, wherein the table is available from a mobile communication company by means of a download.

5. A method for providing a receiver situation mode service in a mobile communication terminal, the method comprising the steps of:
providing a table including data representing a plurality of situation modes of the receiver and codes corresponding to the plurality of situation modes of the receiver;
outputting a code corresponding to a situation mode of the receiver with reference to the table when the situation mode of the receiver is selected by a user; and
transmitting the code representing the predetermined situation mode of the receiver selected by the user together with location registration information of a terminal upon receiving a message requesting a location registration of the terminal.

6. A method as claimed in claim 5, wherein information regarding the situation mode of the receiver is at least one of an icon and a voice message.

7. A method as claimed in claim 5, wherein the table is available from a mobile communication company by means of a download.

8. A method for providing a receiver situation mode service in a mobile communication terminal, the method comprising the steps of:
providing a table including data representing a plurality of situation modes of the receiver and codes corresponding to the plurality of situation modes of the receiver;
transmitting a communication service call requesting voice communication or a real time response, and checking whether a code representing the situation mode of the receiver is received in response to the communication service call; and
upon receiving the code representing the situation mode of the receiver, transmitting information regarding the situation mode of the receiver corresponding to the received code with reference to the table to a user.

9. A method as claimed in claim 8, wherein information regarding the situation mode of the receiver is at least one of an icon and a voice message.

10. A method as claimed in claim 8, wherein the table is available from a mobile communication company by means of a download.

11. A method for providing a receiver situation mode service in a mobile communication system, the method comprising the steps of:
receiving a situation mode of the receiver from a mobile communication terminal;
determining whether the situation mode of the receiver is set when a call connection is requested to the mobile communication terminal; and
transmitting information informing the situation mode of the receiver to a call-outgoing terminal without assigning a channel to the mobile communication terminal when the situation mode is set in the mobile communication terminal.

12. A method as claimed in claim 11, further comprising the step of providing information informing the situation mode of the receiver to a user of using the call-outgoing terminal.

13. A method as claimed in claim 11, wherein the situation mode of the receiver is stored in a database of each user in a home location register of the mobile communication system.
